(19) United States
(12) Patent Application Publication
(10) Pub. No.: US 2007/0064072 A1
(43) Pub. Date: Mar. 22, 2007

(54) Set of ink cartridges, ink cartridge and ink jet printer

(75) Inventor: Naoki Katayama, Kariya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/604,702

(22) Filed: Nov. 28, 2006

Related U.S. Application Data
(63) Continuation of application No. 10/949,343, filed on Sep. 27, 2004, now Pat. No. 7,152,954.

(30) Foreign Application Priority Data
Sep. 30, 2003 (JP) 2003-341668

(51) Int. Cl. B41J 2/175

(52) U.S. Cl. 347/86

(57) ABSTRACT

Ink cartridges 10a to 10d have different patterns from each other in positional relationship between projections 12a to 12d and insertion parts 16a to 16d, respectively, and cartridge holders 20a to 20d have different patterns from each other in positional relationship between slits 22a to 22d and ink introducing tubes 21a to 21d, as seen from the direction on which the ink cartridges 10a to 10d are mounted on the cartridge holders 20a to 20d, respectively. At the same time, the respective patterns of the positional relationships in the ink cartridges and the cartridge holders coincide with each other per each of the four colors of black, cyan, yellow and magenta. Thus, any one of ink cartridges is prevented from inadvertently joined to any one of the cartridge holders to which the ink cartridge does not correspond to.

This is a Continuation of Application No. 10/949,343 filed Sep. 27, 2004. The entire disclosure of the prior application is hereby incorporated by reference herein in its entirety.

### FIELD OF THE INVENTION

The present invention relates to a set of ink cartridges which are filled with a plurality of kinds of inks, ink cartridges included in the set, a method for producing the set of ink cartridges, and an ink jet printer which forms an image with the inks contained in these ink cartridges.

### BACKGROUND OF THE INVENTION

In general, an ink jet printer (ink jet recording apparatus) has a construction in which an ink cartridge filled with an ink are adopted to be installed to or mounted on a cartridge case. In such a printer, the ink contained in the ink cartridge mounted on the cartridge case is supplied to a recording head main body through an ink supply needle. (See, for example, Japanese Patent Application Laid-open No. 2000-218813.)

Japanese Patent Application Laid-open No. 2000-218813 discloses an ink jet printer having a cartridge case divided into a larger compartment and a smaller compartment. The larger compartment of the ink cartridge case are provided with three projections in the periphery of respective ink supply needles in an upstanding manner, and the height of the projections is greater than that of ink supply needles. A ink cartridge has three recesses formed in the lower surface thereof for engaging with the three projections of the ink cartridges cases. Accordingly, when the ink cartridges are mounted on the ink cartridge case, it is necessary that the positions of three projections and the positions of three recesses coincide with each other. Otherwise, the ink cartridge cannot be mounted on the ink cartridge case.

Accordingly, by changing the positions in which the projections and recesses are formed or the shape of the projections and recesses per each model of printer, it is possible to ensure that an ink cartridge is mountable only to a cartridge case included in the model of printer to which the ink cartridge corresponds. As a result, it is possible to prevent the ink cartridge from being mounted by mistake on a model of printer to which the ink cartridge does not correspond to.

The countermeasures to prevent such a mis-installation of ink cartridge are often adopted also for an ink jet printer which performs high-quality color printing with a plurality of ink cartridges each corresponding to different kinds of color inks. In other words, in such a printer, when the user mounts one or more ink cartridge or cartridges on a compartment or compartments of the cartridge case corresponding to the color other than that of the ink cartridge, problems arise such that the inks of different colors are mixed in the cartridge case and the ink cartridge cannot be used. Thus, it is necessary to prevent the ink cartridge of one color from being mounted on the compartment of the cartridge case of color different from that of the ink cartridge. In some cases, ink cartridges having a same shape regardless of the kind of inks are used for such a printer. These ink cartridges are affixed with labels for distinguishing the colors thereof and constructed so that the user cannot mount an ink cartridge of one color on the compartments of ink cartridge case corresponding to a color different from that of the ink cartridge.

As the methods for distinguishing the colors of inks contained in the ink cartridges include, for example, a method to cut a predetermined projection among the plurality of projections provided in the respective surfaces of the ink cartridges, a method to change the shapes of ink cartridges per each of the colors or the positions of insert dies used when the ink cartridges are molded, and a method to attach components for distinguishing colors to the ink cartridges. However, with these methods as described above, problems arise such as one or more extra step or steps in the process for producing the cartridges are required, the mold cost is increased, and/or the number of parts are increased, thereby raising the mold and control costs.

### SUMMARY OF THE INVENTION

A primary object of the present invention is to provide a set of ink cartridges and ink cartridge prevented from being mounted in wrong cartridge mounting parts or cartridge holders, and provide an ink jet printer for use with such a set of ink cartridges.

In accordance with a first aspect of the present invention, there is provided a set of plurality of ink cartridges (10a to 10d) which are mounted on mounting parts (20a to 20d) of an ink jet printer and which store different inks, wherein:
each of the ink cartridges comprises:
a cartridge body (11a, 11b, 11c, 11d, 15a, 15b, 15c or 15d);
an ink supplying part (16a, 16b, 16c or 16d) provided in the cartridge body; and
an engaging part (12a, 12b, 12c or 12d) for engaging with one of the mounting parts when an ink cartridge is mounted on the one of mounting parts; and
the cartridges have different patterns from each other in positional relationship between the ink supplying part and the engaging part, as seen from a direction (AA) in which the ink cartridges are mounted on the mounting parts.

Thus, the cartridges have different positional relationship between the ink supplying part and the engaging part from each other. This prevents each of the ink cartridges, for example the cartridge storing a black ink, from being mounted on any one of the wrong cartridge mounting parts, for example the cartridge holder connected to the nozzle for ejecting an yellow ink. Each of the plurality of ink cartridges may include a cartridge body and a member which have an engaging part and an ink supplying part respectively formed therein. In one of the ink cartridges, the cartridge body and the member are joined to each other with the engaging and supplying parts arranged in a pattern different from those for the other ink cartridges. In this case, the cartridge bodies and the members of the ink cartridges can be common to all of the ink cartridges, so that the cartridges can be produced at low cost. Each of the mounting parts may have a positioning part for engaging with the engaging part of an associated ink cartridge of the ink cartridges.

In accordance with a second aspect of the present invention, there is provided an ink jet printer (1) on which a plurality of ink cartridges (10a to 10d) are mounted, the ink cartridges each including a cartridge body (11a, 11b, 11c, 11d, 15a, 15b, 15c or 15d) and an ink supplying part (16a, 16b, 16c or 16d) provided in the cartridge body, the ink cartridges storing different inks, wherein:

the ink jet printer has a plurality of cartridge mounting parts (20a to 20d) on which the plurality of ink cartridges are mounted, respectively;

each of the cartridge mounting parts includes:

an ink introducing part (21a, 21b, 21c or 21d) which is connected to the supplying part of an associated ink cartridge of the ink cartridges and introduces ink thereto; and

a positioning part (22a, 22b, 22c or 22d) which positions the associated ink cartridge in a predetermined position; and

the cartridge mounting parts have different patterns from each other in positional relationship between the ink introducing part and the positioning part, as seen from a direction (AA) in which the ink cartridges are mounted on the mounting parts.

Thus, the cartridge mounting parts have different positional relationships between the ink introducing part and the positioning part from each other. This prevents each of the ink cartridges from being mounted in any one of the wrong cartridge mounting parts.

The positioning parts may be respectively provided in a same position in the cartridge mounting parts. This makes it possible to mount the ink cartridges, with their engaging parts oriented in the same direction.

The ink introducing parts may be respectively provided in a same position in the cartridge mounting parts. This makes it possible to mount the ink cartridges, with their ink supplying parts oriented in the same direction.

The cartridge mounting parts may be arranged in a line. This makes it possible to reduce the width of a portion in which the cartridge mounting parts in the ink jet printer.

In the ink jet printer of the present invention, respective ink introducing parts of two adjacent cartridge mounting parts may be provided close to each other. This makes it possible to arrange the ink introducing parts in a concentrated manner so as to condense the ink channels, thereby reducing the space for the ink channels in the ink jet printer.

The cartridge mounting parts may have four cartridge mounting parts arranged in a form of a lattice. This makes it possible to arrange the cartridge mounting part in a compact manner.

The ink introducing parts of the four cartridge mounting parts may be concentrated inward as seen in the direction in which the ink cartridges are mounted on the cartridge mounting parts. This makes it possible to arrange the ink introducing parts in a concentrated manner so as to condense the ink channels, thereby reducing the space for the ink channels in the ink jet printer.

The ink jet printer may comprise the plurality of ink cartridges. Each of the ink cartridges may include an engaging part for engaging with the positioning part of an associated cartridge mounting part. The cartridge body of each of the ink cartridges may have a first member for containing ink, and a second member; the first member has an engaging part for engaging with the positioning part of an associated cartridge mounting part of the cartridge mounting parts; and a first joining part for joining the first member to the second member; the second member has a second joining part which enables the second member to be joined to the first joining part in one of various orientations; and the ink supplying part provided off the center of the second joining part.

In accordance with a third aspect of the present invention, there is provided an ink cartridge which stores ink to be supplied to an ink jet printer, the cartridge comprising:

a first member (11a, 11b, 11c or 11d); and

a second member (15a, 15b, 15c or 15d) which is joined to the first member, wherein:

the first member has an engaging part (12a, 12b, 12c or 12d) for positioning the ink cartridge in a predetermined position in the ink jet printer, and a first joining part (14a, 14b, 14c or 14d) for joining the first member to the second member;

the second member (18a, 18b, 18c or 18d) has a second joining part which enables the second member to be joined to the first joining part in one of various orientations, and an ink supplying part (16a, 16b, 16c or 16d) provided off a center (AX, BX, CX or DX) of the second joining part.

It is possible to produce a plurality of ink cartridges by joining the first and second members of each of the cartridges together, with the associated supplying and engaging parts arranged relative to each other in a pattern different from those for the other cartridges. Accordingly, the first and second members of the ink cartridges can be common to all of them. This reduces the number of parts of the ink cartridges, so that the cartridges can be produced at low cost. Each of the first joining part (14a to 14d) and the second joining part (18a to 18d) may be formed with rotational symmetry.

In the ink cartridge of the present invention, the first member may be an ink container, and the second member may be a lid for closing an opening of the ink container. This makes it possible to assemble different ink cartridges from two types of parts. Consequently, the number of parts of the ink cartridges is reduced, so that the cartridges can be produced at low cost.

In the ink cartridge of the present invention, the lid and the opening of the ink container respectively may have a shape of a circle or a regular polygon. This makes it easy to determine different joining postures.

In the ink cartridge of the present invention, the lid and the opening of the ink container respectively may have a shape of a regular polygon, and a number of the plurality of postures in which the lid is joined to the ink container may equal a number of sides of the polygon. This makes it possible to determine different joining positions without using special structure or member.

In the ink cartridge of the present invention, the ink jet printer may include an ink cartridge mounting part in which the ink cartridge is mounted, the ink cartridge mounting part having an ink introducing part provided in a position corresponding to the position of the ink supplying part of the ink cartridge. This makes it possible to supply the ink jet head reliably with the inks in the cartridges mounted on the printer.

It is possible to provide a set of ink cartridges using a plurality of ink cartridges of the present invention. In this case, the ink cartridges may be assembled with the first and second joining parts joined in different orientations. In the thus obtained set of ink cartridges, the ink cartridges may have different positional relationships between the ink supplying part and the engaging part from each other. This makes it possible to assemble different ink cartridges from the same parts.

In accordance with a fourth aspect of the present invention, there is provided a method for producing such a set of ink cartridges, the method comprising the steps of:

assembling a first ink cartridge (10a) by joining the first joining part (14a) of the first member (11a) of the first ink cartridge and the second joining part (18a) of the second member (15a) of the first ink cartridge together in a predetermined orientation; and

assembling a second ink cartridge (10b) by joining the first joining part (14b) of the first member (11b) of the second ink cartridge and the second joining part (18b) of the second member (15b) of the second ink cartridge together in another orientation different from the predetermined orientation.

In this case, the first and second joining parts may be in rotational symmetry.

### BRIEF DESCRIPTION OF THE DRAWINGS

FIG. 1 shows a schematic arrangement of an ink jet printer according to a first embodiment of the invention;

FIG. 2 is a perspective view of ink cartridges 10a to 10d;

FIG. 3 is a top view of the ink cartridges 10a to 10d;

FIG. 4A is a vertical cross section of the ink container 11a of the black ink cartridge 10a shown in FIGS. 2 and 3;

FIG. 4B is a bottom view of the ink container 11a;

FIG. 4C is a top view of the lid 15a of the black ink cartridge shown in FIGS. 2 and 3;

FIG. 4D is a vertical cross section of the lid 15a;

FIG. 4E is a vertical cross section of the black ink cartridge 10a shown in FIGS. 2 and 3;

FIG. 5 is a perspective view of the cartridge receiving parts or cartridge holders 20a to 20d shown in FIG. 1;

FIG. 6 is a top view of the cartridge holders 20a to 20d;

FIG. 7 is a perspective view of a state in which the ink cartridges 10a to 10d are mounted on the cartridge holders 20a to 20d, respectively;

FIG. 8 is a top view of a state in which the ink cartridges 10a to 10d are mounted on the cartridge holders 20a to 20d, respectively;

FIG. 9 is a perspective view of the cartridge holders 120a to 120d of an ink jet printer according to a second embodiment of the invention;

FIG. 10 is a top view of the cartridge holders 120a to 120d with the ink cartridges 120a to 120d mounted thereon;

FIG. 11 is a perspective view of ink cartridges 210a to 210d for use in ink jet printers according to a third embodiment, a fourth embodiment and a fifth embodiment of the invention;

FIG. 12 is top view of the ink cartridges 210a to 210d;

FIG. 13A is a vertical cross section of the ink container 211a of the black ink cartridge 210a shown in FIGS. 11 and 12;

FIG. 13B is a bottom view of the ink container 211a;

FIG. 13C is a top view of the lid 215a of the black ink cartridge 210a shown in FIGS. 11 and 12;

FIG. 13D is a vertical cross section of the lid 215a;

FIG. 13E is a vertical cross section of the black ink cartridge 210a shown in FIGS. 11 and 12;

FIG. 14 is a perspective view of the cartridge holders 220a to 220d of the printer according to the third embodiment;

FIG. 15 is a top view of the cartridge holders 220a to 220d;

FIG. 16 is a perspective view of the cartridge holders 220a to 220d with the ink cartridges 210a to 210d mounted thereon;

FIG. 17 is a top view of the cartridge holders 220a to 220d with the ink cartridges 210a to 210d mounted thereon;

FIG. 18 is a top view of the cartridge holders 320a to 320d of the printer according to the fourth embodiment with the ink cartridges 210a to 210d mounted on the cartridge holders;

FIG. 19 is a top view of the cartridge holders 410a to 410d of the printer according to the fifth embodiment with the ink cartridges 210a to 210d mounted on the cartridge holders;

FIG. 20A is a perspective view of an ink cartridge 510afor use in an ink jet printer according to a sixth embodiment of the invention;

FIG. 20B is a top view of the ink cartridge 510a;

FIG. 21 is a top view of the cartridge holders 520a to 520g of the printer according to the sixth embodiment with the ink cartridges 510a to 510g mounted on the cartridge holders.

### DESCRIPTION OF THE PREFERRED EMBODIMENTS OF THE INVENTION

### First Embodiment

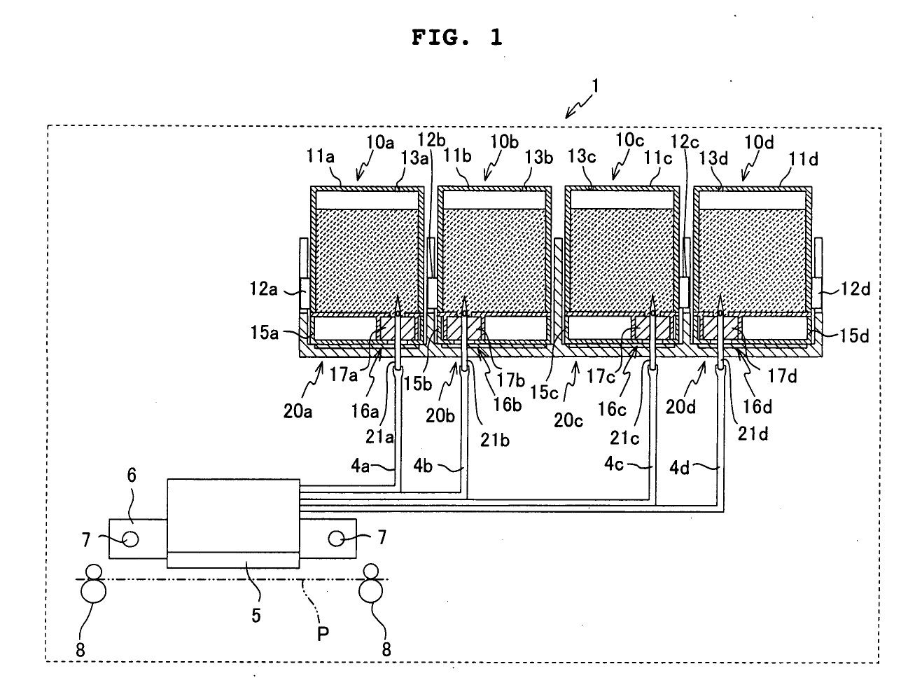

An explanation will be made regarding the preferred embodiments of the present invention. FIG. 1 shows a schematic arrangement of an ink jet printer 1 according to a first embodiment of the present invention.

The printer 1 includes a plurality of ink cartridges 10a to 10d filled with inks of black, cyan, yellow and magenta colors, respectively; cartridge receiving parts or cartridge holders 20a to 20d on which the ink cartridges 10a to 10d are detachably mounted; an ink jet head 5 (hereinafter referred to simply as “head 5) which discharges ink onto paper P, the inks being supplied to the head 5 from the ink cartridges 10a to 10d mounted on the cartridge holders 20a to 20d through supplying tube 4a to 4d, respectively; a carriage 6 in which the head 5 is mounted and which reciprocates in a linear direction along a carriage shaft 7 which serves as a guide when the carriage 6 makes the reciprocating motion; and a transport mechanism 8 which transports the paper P.

The ink cartridges 10a to 10d include ink containers 11a to 11d which stores the ink, and lids 15a to 15d joined thereto, respectively. Projections 12a to 12d are provided in the outer circumferential surface of the ink containers 11a to 11d, respectively. In the lids 15a to 15d, insertion parts 16a to 16d are provided for receiving ink introducing tubes 21a to 21d. Plugs 17a to 17d, which seal the inner space of the ink cartridges 11a to 11d, respectively, are compressed into the insertion parts 16a to 16d. The inner side surface of the respective plugs 17a to 17d make contact with the ink contained in the respective ink cartridges 10a to 10d. Air holes 13a to 13d are formed in the closed surfaces (upper surfaces in FIG. 1) of the ink containers 11a to 11d, respectively.

The cartridge holders 20a to 20d are parts on which the ink cartridges 10a to 10d are mounted, respectively. In the respective bottom surfaces of the cartridge holders 20a to 20d, hollow needle-shaped ink introducing tubes 21a to 21d are provided to protrude therethrough the bottom surfaces.

When the cartridges 10a to 10d are mounted on the cartridge holders 20a to 20d, respectively, the tips of the ink-introducing tubes 21a to 21d pierce the plugs 17a to 17d, respectively, and are entered inside the ink cartridges 10a to 10d, thereby making contact with the respective inks in the ink cartridges 10a to 10d. Since each of the plugs 17a to 17d is formed of an elastic material like butyl rubber so that the ink-introducing tubes 21a to 21d are capable of piercing the plugs 17a to 17d and the plugs 17a to 17d are compressed into the insertion parts 16a to 16d, the elastic function of the plugs maintains the tightly sealed or closed condition in the ink containers 11a to 11d even after the ink introducing tubes 21a to 21d are pulled out.

As described above, when the ink is discharged from the head 5 to the paper P after the ink cartridges 10a to 10d are mounted on the cartridge holders 20a to 20d, respectively, the ink, which corresponds to the discharged amount, is supplied from each of the ink cartridges 10a to 10d to the head 5 through the respective supply tubes 4a to 4d. At this time, the air is introduced into the ink cartridges 10a to 10d from the air holes 13a to 13d of the ink containers 11a to 11d, respectively.

The head 5 has a plurality of nozzles (not shown) which discharges the ink. Accordingly, the ink, supplied from the ink cartridges 10a to 10d to the head 5 through the supply tubes 4a to 4d, are discharged from the plurality of nozzles. During the printing operation, the ink is discharged while the carriage 6 reciprocates the printing of the printing paper P.

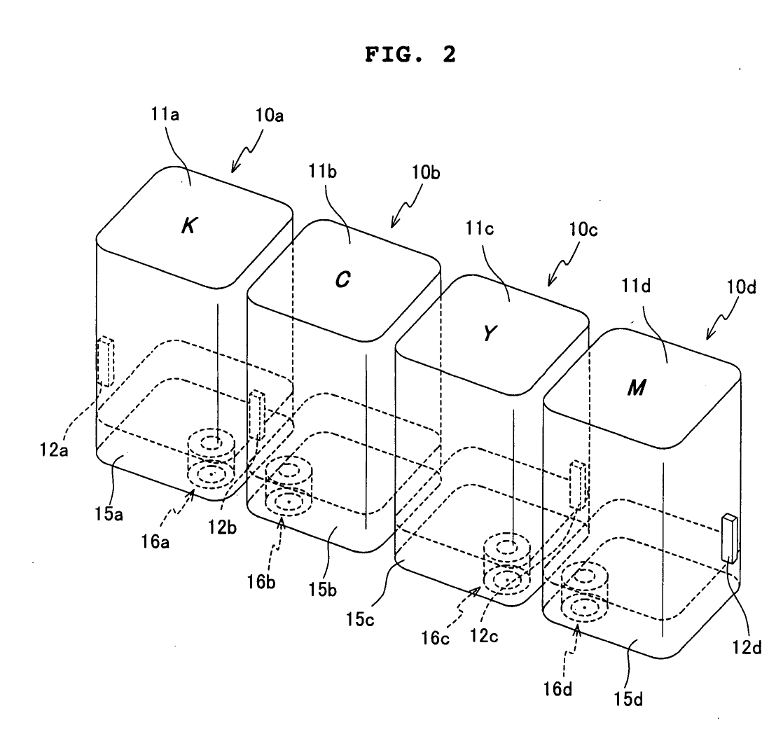

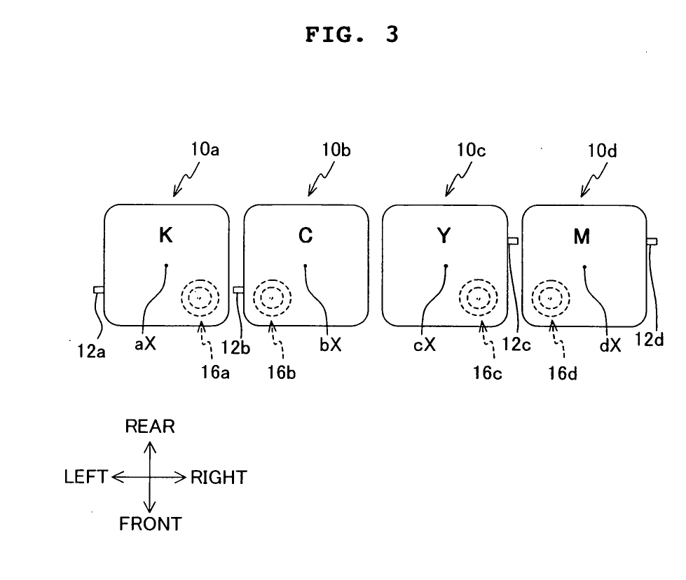

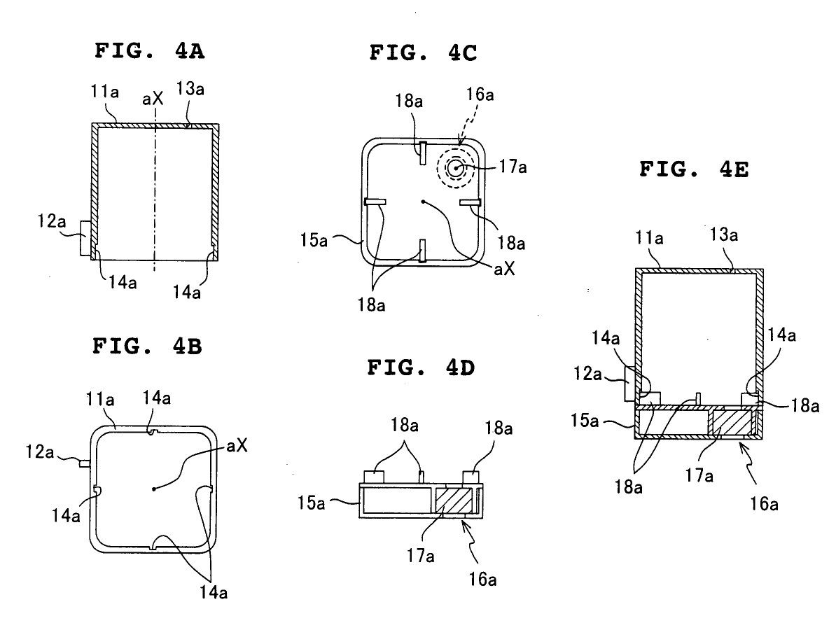

Next, an explanation will be made regarding a detailed construction of the ink cartridges 10a to 10d with reference to FIGS. 2, 3 and 4A to 4E. FIGS. 2 is a perspective view and FIG. 3 is a top view of the ink cartridges 10a to 10d. FIG. 4 is a diagram showing a schematic arrangement of the ink container 11a and the lid 15a included in the ink cartridge 10a corresponding to the black color. Specifically, FIG. 4A shows a vertical cross section of the ink container 11a, FIG. 4B shows a horizontal cross section and bottom view of the ink container 11a, FIG. 4C shows a top view of the lid 15a, and FIG. 4D shows a vertical cross section of the lid 15a. FIG. 4E shows a vertical cross section of the ink cartridge 10a in which the ink container 11a and the lid 15a are joined to each other.

As described above, in ink cartridge 10a, the ink container 11a and the lid 15a are joined to each other. As shown in FIGS. 2 and 4, the ink container 11a is a tubular member which is substantially square in horizontal cross section. The projection 12a is provided near one corner of the container 11a. The top of the ink container 11a is closed except for the portion where the air hole 13a (not shown in FIGS. 2 to 4) is formed. The bottom of the ink container 11a is open.

As shown in FIGS. 4A and 4B, four recesses 14a (first joining parts) are formed in the bottom (the end portion on the open side) of the ink container 11a. In the respective inner side surfaces of the bottom at the four side surfaces of the ink container 11a, the recesses 14a are arranged in the center of the respective inner side surfaces. In other words, the recesses 14a have rotational symmetry with the center (axis) aX in the bottom of the ink container 11a, the portions corresponding to the recesses 14a are thin.

The lid 15a closes an opening of the bottom of the ink container 11a, and the projected configuration of the lid 15a is approximately same as that of the ink container 11a. The insertion part 16a of the lid 15a is arranged near one corner of the lid. As shown in FIGS. 4C and 4D, four ribs 18a (second joining parts) are provided on the upper surface (surface joined to the ink container 11a) of the lid 15a to protrude upwardly therefrom. The four ribs 18a are formed in the vicinity of the outer periphery of the lid 15a, and are positioned in the center of the respective four side surfaces of the lid 15a. As a result, these ribs 18a are in rotational symmetry with the center aX of the lid 15a. The outer end portion of each rib 18a is spaced by a predetermined distance from the outer periphery of the lid 15a toward the inner side of the lid 15a. The predetermined distance is approximately equal to the thickness of the thinned portion in the bottom of the ink container 11a.

The width and height of the four recesses 14a of the container 11a are approximately equal to those of the outer end portion of the ribs 18a of the lid 15a. Accordingly, when the lid 15a is joined to the container 11a, it is possible to engage the outer end of the rib 18a into the recess 14a. The four recesses 14a and the four outer ends of the ribs 18a are same in shape, and are formed at identical angular intervals. Further, these recesses 14a are in rotational symmetry with the center aX of the ink container 11a. Accordingly, when the lid 15a is joined to the ink container 11a, it is possible to join the lid 15a to the ink container 11a in any one of four joining postures by turning the lid 15a by 90 degrees for each of the four postures.

FIG. 4E shows the ink cartridge 10a corresponding to the black color, which is formed by joining the lid 15a to the ink container 11a in one of the four joining postures relative to the ink container 11a.

The ink containers 11a to 11d constructing the ink cartridges 10a to 10d corresponding to the black, cyan, yellow and magenta colors, respectively, and the lids 15a to 15d are same in structure. As shown in FIGS. 2 and 3, the joining postures of the lids 15a to 15d to the respective ink containers 11a to 11d are different from each other in the ink cartridges 10a to 10d when the lids 15a to 15d are joined to the respective ink containers 11a to 11d. Thus, the set of ink cartridges of the present invention is produced by joining the lids 15a to 15d to the ink containers 11a to 11d, respectively in this manner.

FIG. 3 shows a top view of the ink cartridges 10a to 10d produced by joining the lids 15a to 15d in the respective four joining postures to the ink containers 11a to 11d, respectively. In FIG. 3, front/near and left/right directions are indicated by arrows for explanation of configuration of the cartridges 10a to 10d.

As shown in FIG. 3, in the ink cartridge 10a corresponding to the black color, the projection 12a is arranged in a position off the center of the left side surface toward the front side. The insertion part 16a is arranged in a position in the vicinity of the right side surface opposed to the left side surface where the projection 12a is arranged, and off the center aX of the ink cartridge 10a toward the front-right corner thereof. On the other hand, in the ink cartridge 10b corresponding to the cyan color, the projection 12b is arranged, as in the case of the projection 12a, in a position off the center of the left side surface toward the front side. The insertion part 16b is arranged in a position in the vicinity of the left side surface where the projection 12b is arranged, and off the center bX of the ink cartridge 10b toward the front-light corner thereof.

Similarly, in the ink cartridge 10c corresponding to the yellow color, the projection 12c is arranged in a position off the center of the right side surface toward the rear side. The insertion part 16c is arranged, as in the case of the insertion part 16a, in a position in the vicinity of the right side surface where the projection 12c is arranged, and off the center cX of the ink cartridge 10c toward the front-right corner thereof. On the other hand, in the ink cartridge 10d corresponding to the magenta color, the projection 12d is arranged, as in the case of the projection 12c, in a position off the center of the right side surface toward the rear side. The insertion part 16d is arranged, as in the case of the insertion part 16b, in a position in the vicinity of the left side surface opposed to the right side where the projection 12d is arranged, and off the center dX of the ink cartridge 10d toward the front-left corner thereof.

As shown in FIG. 3, in the ink cartridges 10a to 10d, the insertion parts 16a to 16d are positioned respectively eccentric from (arranged off) the center aX to dX of the ink cartridges 10a to 10d, respectively.

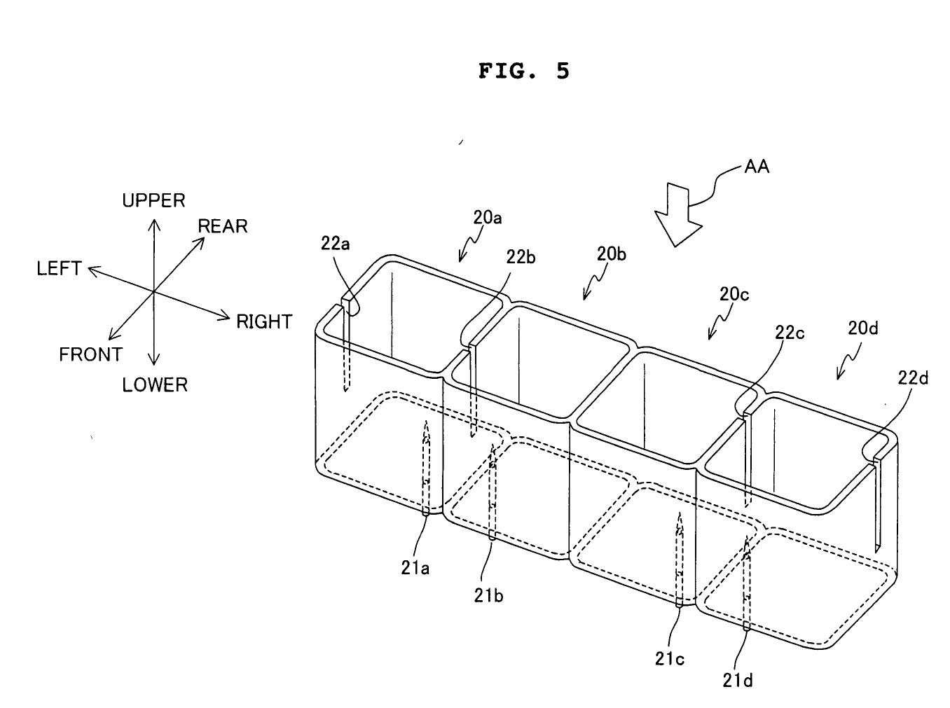

Thus, FIG. 3 shows the ink cartridges 10a to 10d corresponding to the black, cyan, yellow and magenta colors respectively in this order from the left side to the right side. However, the projections 12a to 12d are arranged differently relative to the corresponding insertion parts 16a to 16d around the centers aX to dX of the associated ink cartridges 10a to 10d. In other words, the respective patterns of the positional relationship between the projections 12a to 12d and the insertion parts 16a to 16d, respectively, are different from each other seen from a direction in which the ink cartridges 10a to 10d are mounted (as seen from the direction of arrow AA in FIG. 5).

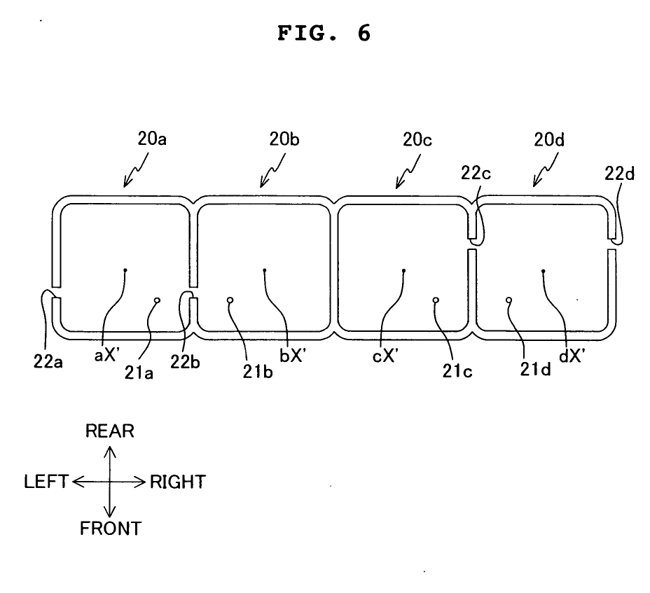

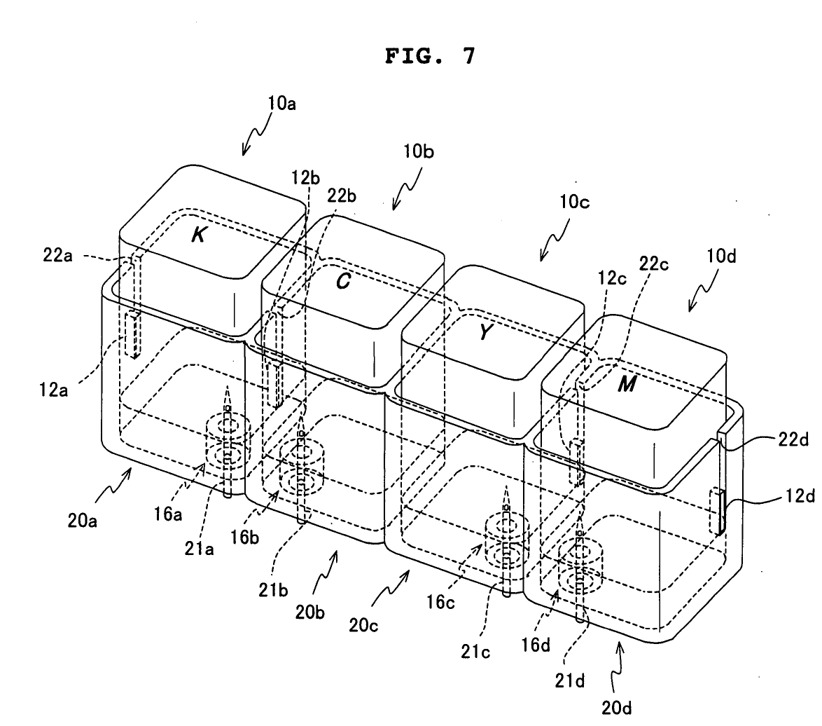

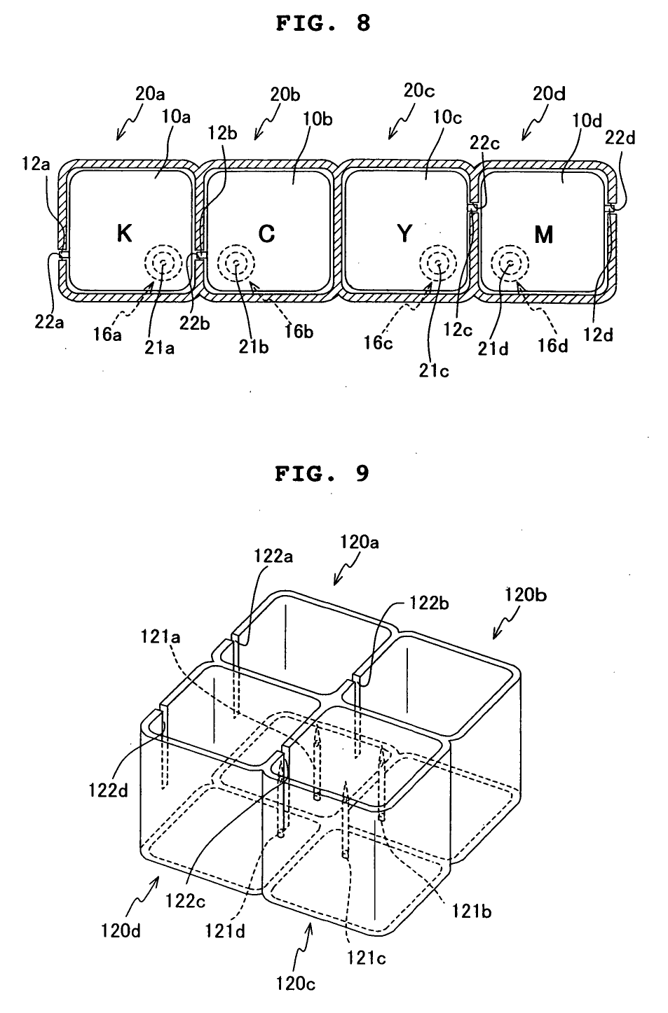

Next, an explanation will be made regarding a detailed construction of the cartridge holders 20a to 20d with reference to FIGS. 5 to 8. FIGS. 5 and 6 are perspective and top views of the cartridge holders 20a to 20d, respectively. FIG. 7 and 8 are perspective and top views showing a state in which the ink cartridges 10a to 10d are mounted on the cartridge holders 20a to 20d, respectively. In FIG. 5, the upper/lower, front/rear and left/right directions corresponding to the view of FIG. 3 are shown by arrows for explanation of the configuration of the cartridge holders 20a to 20d.

As shown in FIG. 5, the cartridge holders 20a to 20d have a substantially box-shaped member for mounting the ink cartridges 10a to 10d thereon, respectively. The cartridge holders 20a to 20d are arranged in a line. The cross sectional area of the inner space of the respective cartridge holders 20a to 20d is approximately same as that of the cross sectional area of the ink cartridges 10a to 10d. In this embodiment, the cartridge holders 20a to 20d are integrally formed and constructed with one member.

As described above, the ink introducing tubes 21a to 21d are provided in the bottom surface of the cartridge holders 20a to 20d to protrude upwardly therefrom. In the cartridge holders 20a to 20d, the ink introducing tubes 21a to 21d are positioned respectively eccentric from (arranged off) the center of the bottom surface. The tips of the ink introducing tubes 21a to 21d are located in the vicinity of the middle of the cartridge holders 20a to 20d in the height thereof, respectively.

In the two adjacent cartridge holders 20a, 20b, the ink introducing tubes 21a, 21b are provided close to each other. Similarly, in the two adjacent cartridge holders 20c, 20d, the ink introducing tubes 21c, 21d are provided close to each other.

The cartridge holders 20a to 20d have slits 22a to 22d formed on side surfaces, respectively. The projections 12a to 12d of the ink containers 11a to 11d are engaged with the slits 22a to 22d, respectively. The slits 22a to 22d extend downwardly from the respective tops of the cartridge holders 20a to 20d toward the vicinity of the middle in the height thereof.

As shown in FIG. 6, in which front/near and left/right directions are indicated by arrows for explanation of configuration of the cartridge holders 20a to 20d, the slit 22a is arranged in a position off the center of the left side surface toward the front side in the cartridge holder 20a corresponding to the black color. The ink introducing tube 21a is arranged in a position in the vicinity of the right side surface opposed to the left side surface where the slit 22a is arranged, and off the center aX′ of the cartridge holder 20a toward the front-right corner thereof. On the other hand, in the cartridge holder 20b corresponding to the cyan color, the slit 22b is arranged, as in the case of the slit 22a, in a position off the center of the left side surface toward the front side. The ink introducing tube 21b is arranged in a position in the vicinity of the left side surface where the slit 22b is also arranged and off the center bX′ of the cartridge holder 20b toward the front-left corner thereof.

Similarly, as shown in FIG. 6, in the cartridge holder 20c corresponding to the yellow color, the slit 22c is arranged in a position off the center of the right side surface toward the rear side. The ink introducing tube 21c is arranged, as in the case of the ink introducing tube 21a, in a position in the vicinity of the right side surface where the slit 22c is arranged, and off the center cX′ of the cartridge holder 20c toward the front-right corner thereof. On the other hand, in the cartridge holder 20d corresponding to the magenta color, the slit 22d is arranged, as in the case of the slit 22c, in a position off the center of the right side surface toward the rear side. The ink introducing tube 21d is arranged, as in the case of the ink introducing tube 21b, in a position in the vicinity of the left side surface opposed to the right side surface where the slit 22d is arranged, and off the center dX′ of the cartridge holder 20d toward the front-left corner thereof.

Thus, FIG. 5 shows the cartridge holders 20a to 20d for the ink cartridges 10a to 10d corresponding to the black, cyan, yellow and magenta colors respectively in this order from the left side to the right side. However, each of the slits 22a to 22d is arranged differently relative to the corresponding ink introducing tubes 21a to 21d around the centers aX′ to dX′ of the associated cartridge holders 20a to 20d. In other words, the respective patterns of the positional relationship between the slits 22a to 22d of the cartridge holders 20a to 20d and the ink introducing tubes 21a to 21d, respectively, are different from each other, as seen from a direction in which the ink cartridges 10a to 10d are mounted (as viewed from the direction of arrow AA in FIG. 5).

As understood from the foregoing explanation, the respective patterns of positional relationship between the projections 12a to 12d and the insertion parts 16a to 16d of the ink cartridge 10a to 10d and the respective patterns of positional relationship between the slits 22a to 22d of the cartridge holders 20a to 20d and the ink introducing tubes 21a to 21d are same per each of the colors of black, cyan, yellow and magenta. Accordingly, as shown in FIGS. 7 and 8, it is possible to appropriately mount the cartridges 10a to 10d on the cartridge holders 20a to 20d, respectively, without any misfit by the user.

For example, an consideration is made regarding the movement when the ink cartridge 10a corresponding to the black color is mounted on the cartridge holder 20a corresponding to the black color. When the ink cartridge 10a is moved over the cartridge holder 20a, and the projection 12a is engaged with the slit 22a and entered toward the bottom surface of the cartridge holder 20a, the position of the ink introducing tube 21a coincides with the position of the insertion part 16a. Accordingly, when the ink cartridge 10a is continuously entered toward the bottom surface of the cartridge holder 20a, the ink introducing tube 21a is capable of entering into the insertion part 16a. Thus, it is possible to mount ink cartridge 10a on the cartridge holder 20a.

On the other hand, an consideration is made regarding the movement when the ink cartridge 10a corresponding to the black color is mounted on one of the cartridge holders 20b to 20d corresponding to the colors other than black. When the ink cartridge 10a is moved over any one of the cartridge holders 20b to 20d, and the projection 12a is engaged with any one of the slits 22b to 22d and entered toward the bottom surface of any one of the cartridge holders 20b to 20d, the position of any one of the ink introducing tubes 21b to 21d does not coincide with the position of the insertion part 16a. Accordingly, when the ink cartridge 10a is continuously entered toward the bottom surface of any one of the cartridge holders 20b to 20d, any one of the ink introducing tubes 21b to 21d abuts against the portion other than the insertion part 16a in the bottom surface of the ink cartridge 10a. Thus, it is impossible to mount the ink cartridge 10a on any one of the cartridge holders 20b to 20d.

As a result, as shown in FIG. 8, only when the ink cartridges 10a to 10d corresponding to the black, cyan, yellow and magenta colors are mounted on the corresponding cartridge holders 20a to 20d, respectively, the projections 12a to 12d are engaged with the slits 22a to 22d, respectively, and the ink introducing tubes 21a to 21d are entered in the insertion parts 16a to 16d, respectively, thereby realizing the appropriate mount.

As described above, in the ink jet printer 1 of this embodiment, as seen from the direction in which the ink cartridges 10a to 10d are mounted (in the case of FIG. 8, seen from above the sheet surface of the drawing), the respective patterns of positional relationship between the projections 12a to 12d and the insertion parts 16a to 16d, respectively, are different from each other, and the respective patterns of the positional relationship between the slits 22a to 22d of the cartridge holders 20a to 20d and the ink introducing tubes 21a to 21d are different from each other. However, the respective patterns of the positional relationships in the ink cartridges and the cartridge holders coincide with each other per each of the four colors of black, cyan, yellow and magenta. In this manner, by making the positional relationship between the projections 12a to 12d and the insertion parts 16a to 16d in the ink cartridges 10a to 10d and the positional relationship between the slits 22a to 22d and the ink introducing tubes 21a to 21d in the cartridge holders 20a to 20d different from each other per each of a plurality of different colors, it is possible to prevent any one of the ink cartridges 10a to 10d from inadvertently being mounted on any one of the cartridge holders 20a to 20d to which the ink cartridge does not correspond to.

In addition, it is possible to produce the ink cartridges 10a to 10d by joining the projections 12a to 12d to the insertion parts 16a to 16d in four different joining postures, respectively, by turning the lids 15a to 15b by 90 degrees about the centers aX to dX. Accordingly, it is possible to commonly use the ink containers 11a to 11d and the lids 15a to 15d, which are same in construction respectively, for all of the ink cartridges 10a to 10d. Therefore, it is possible to produce four kinds of the ink cartridges 10a to 10d with one kind of the ink container and one kind of the lid, thereby reducing the production cost.

In addition, since the cartridge holders 20a to 20d are arranged in a line, it is possible to reduce the width of a part in the printer 1 where the cartridge holders 20a to 20d are provided.

Further, in the two adjacent cartridge holders 20a, 20b, the ink introducing tubes 21a, 21b are provided close to each other, and in the two adjacent cartridge holders 20c, 20d, the ink introducing tubes 21c, 21d are provided close to each other. Therefore, it is possible to reduce the size of the part constructing an ink flow path in the printer 1.

Since the ink containers 11a to 11d and the lids 15a to 15d are square in horizontal section and thus are in rotational symmetry, it is easy to determine a plurality of joining postures therefor. The number of postures in which the lids 15a to 15d can be joined to the ink containers 11a to 11d equals the number of sides of regular quadrilateral. Accordingly, it is possible to join the lids 15a to 15d to the containers 11a to 11d in different postures without using special structure or member.

In a case in which the patterns of positional relationship between the engaging parts and the insertion parts of a plurality of ink cartridges are same, the colors corresponding to the respective ink cartridges are distinguished by complexly constructing the respective shape of the engaging parts so as to be different from each other. Compared with such a case, in this embodiment, it is unnecessary to complexly construct the respective shapes of the projections 12a to 12d since the respective patterns of positional relationship between the projections 12a to 12d and the insertion parts 16a to 16d of the ink cartridges 10a to 10d are different from each other. In addition, in a case where the shape of the engaging part is complex, the engaging part tends to be easily broken and it is difficult to engage the engage part with the positioning part of cartridge holder. However, with this embodiment, such problems do not arise.

In this embodiment, the lid 15a is joined to the ink container 11a by engaging the outer end portion of the rib 18a to the recess 14a. However, in place of the rib 18a and the recess 14a, any arbitrary joining construction may be adopted in which the lid 15a is joined to the ink container 11a. For example, the circumference of the top of the lid 15a may extend upwardly to have a frame-shaped form which is engageable with the bottom of the ink container 11a. In this case, the top of the lid 15a and the bottom of the ink container 11a construct the respective joining parts, and as in the case in which the lib 18a and the recess 14a are provided, it is possible to construct four different kinds of ink cartridges with the four kinds of patterns for engaging the lid 15a to the ink container 11a. In other words, the outer shape having a quadrangular form of the lid 15a and ink container 11a determines the four engaging patterns in any one of which the lid 15a and the ink container 11a can be joined together.

### Second Embodiment

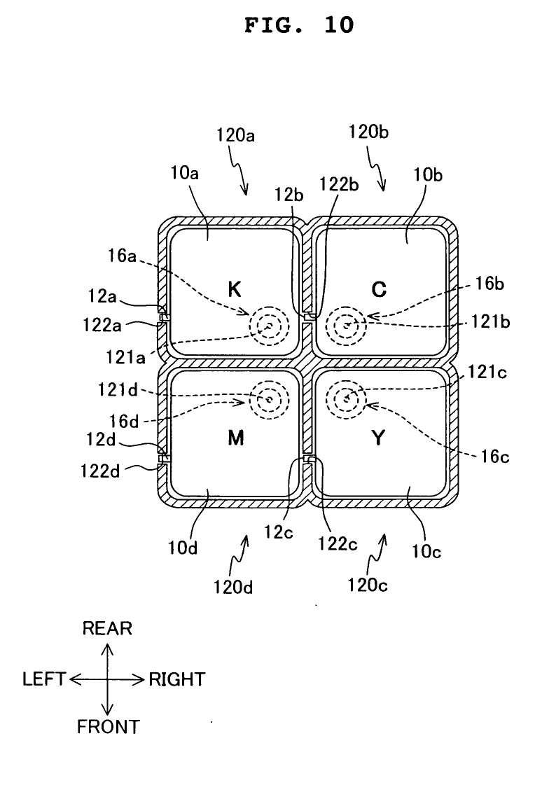

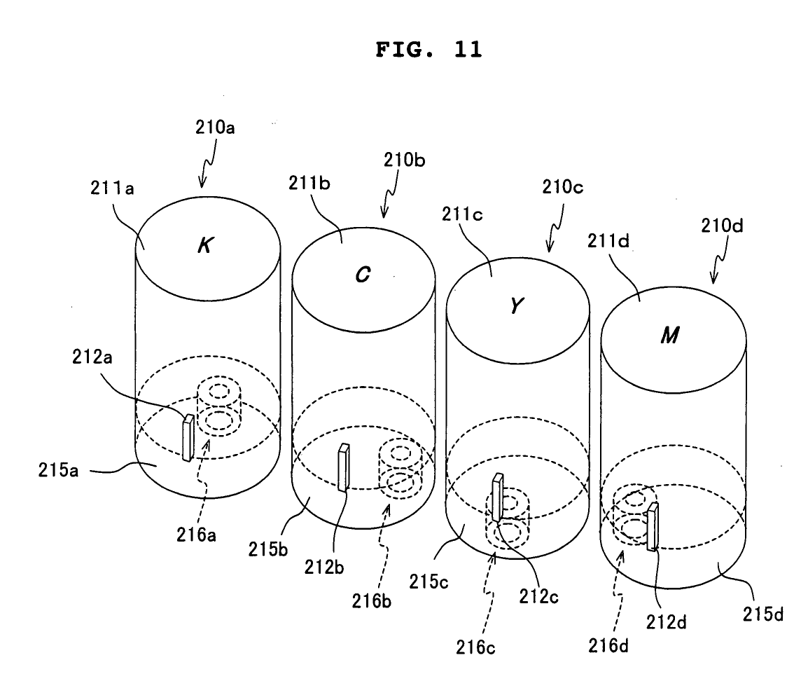

Next, an explanation will be made regarding an ink jet printer of the second embodiment of the present invention with reference to FIGS. 9 and 10. FIG. 9 shows a perspective view of a cartridge holders 120a to 120d included in an ink jet printer according to the second embodiment. FIG. 10 shows a top view illustrating a state in which the ink cartridge 10a to 10d are mounted on the cartridge holder 120a to 120d, respectively. In FIG. 10, front/near and left/right directions are indicated by arrows for explanation of configuration of the cartridges 120a to 120d.

The ink jet printer according to the second embodiment differs from the ink jet printer according to the first embodiment principally in that the cartridge holders 120a to 120d in the second embodiment are arranged in a form of a lattice, whereas the ink cartridge holders 20a to 20d included in the ink jet printer 1 of the first embodiment are arranged in a line. Since the construction of the ink jet printer of the second embodiment other than the above are same as the ink jet printer 1 of the first embodiment, the detailed explanation thereof will be omitted.

The ink cartridge holders 120a to 120d, corresponding to the black, cyan, yellow and magenta colors respectively, have a substantially box-shaped member for mounting the ink cartridges 10a to 10d thereon, respectively. As shown in FIGS. 9 and 10, the cartridge holders 120a to 120d are arranged in the form of a lattice. The construction of the ink cartridge 10a to 10d are same as those explained in the first embodiment.

Ink introducing tubes 121a to 121d are provided on the respective bottom surfaces of the cartridge holders 120a to 120d to protrude upwardly therefrom. In the cartridge holders 120a to 120d, the ink introducing tubes 121a to 121d are arranged so as to be concentrated in the inside of the ink cartridges 120a to 120d, as seen from the direction in which the ink cartridges 10a to 10d are mounted.

The cartridge holders 120a to 120d have slits 122a to 122d each of which is formed on a side surface of the cartridge holder. The slits 122a to 122d engage the projections 12a to 12d of the ink containers 11a to 11d, respectively. The slits 122a to 122d are arranged in a same position relative to the cartridge holders 120a to 120d, respectively, namely in a position off the center of the left side surface and toward the front side.

Further, as seen from the direction in which the ink cartridges 10a to 10d are mounted, the respective patterns of the positional relationship between the slits 122a to 122d of the cartridge holders 120a to 120d and the ink introducing tubes 121a to 121d, respectively, are different from each other.

As shown in FIG. 10, in the cartridge holder 120a corresponding to the black color, the slit 122a is arranged in a position off the center of the left side surface toward the front side. The ink introducing tube 121a is arranged in a position in the vicinity of the right side surface opposed to the left side surface where the slit 122a is arranged, and off the center of the cartridge holder 120a toward the front-right corner thereof. On the other hand, in the cartridge holder 120b corresponding to the cyan color, the slit 122b is arranged in a position off the center of the left side surface toward the front side. The ink introducing tube 121b is arranged in a position in the vicinity of the left side surface where the slit 122b is arranged, and off the center of the cartridge holder 120b toward the front-left corner thereof.

Similarly, in the cartridge holder 120c corresponding to the yellow color, the slit 122c is arranged in a position off the center of the left side surface toward the front side. The ink introducing tube 121c is arranged in a position in the vicinity of the left side surface where the slit 122c is arranged, and off the center of the cartridge holder 120c toward the rear-left corner thereof. On the other hand, in the cartridge holder 120d corresponding to the magenta color, the slit 122d is arranged in a position off the center of the left side surface to the front side. The ink introducing tube 121d is arranged in a position in the vicinity of the right side surface opposed to the left side surface where the slit 122d is arranged, and off the center of the cartridge holder 120d toward the rear-right corner thereof.

Thus, the respective patterns of positional relationship between the projections 12a to 121 and the insertion parts 16a to 16d of the ink cartridges 10a to 11d, and the respective patterns of positional relationship between the slits 122a to 122d of the cartridge holders 120a to 120d and the ink introducing tubes 121a to 121d are same per each of the colors of black, cyan, yellow and magenta.

As a result, when the ink cartridges 10a to 10d corresponding to the black, cyan, yellow and magenta colors respectively, are mounted on the respective corresponding cartridge holders 120a to 120d, as shown in FIG. 10, it is possible to engage the projections 12a to 12d with the slits 122a to 122d, respectively, and to enter the ink introducing tubes 121a to 121d into the insertion parts 16a to 16d, respectively.

As described above, in the ink jet printer of the second embodiment, it is also possible to prevent any one of the ink cartridges 10a to 10d from inadvertently being mounted on any one of the cartridge holders 120a to 120d to which the ink cartridge does not correspond to, as in the case of the first embodiment.

Since the cartridge holders 120a to 120d are arranged in the form of a lattice, it is possible to arrange the cartridge holders 120a to 120d in a compact manner.

Further, since the ink introducing tubes 121a to 122d are arranged so as to be concentrated in the inside of the cartridge holders 120a to 120d, it is possible to reduce the size of the part constructing the ink flow path in the printer 1.

Furthermore, since the slits 122a to 122d are arranged in a same position with respect to the cartridge holders 120a to 120d, respectively, it is possible to mount the ink cartridges 10a to 10d on the cartridge holders 120a to 120d while the projections 12a to 12d are oriented in a same direction.

### Third Embodiment

With reference to FIGS. 11-17, an ink jet printer according to the third embodiment of the present invention is described below.

As described above, the ink cartridges 10a-10d for use in the ink jet printer 1 according to the first embodiment are substantially square in horizontal cross section. The ink jet printer according to the third embodiment differs from the ink jet printer 1 mainly in being for use with substantially cylindrical ink cartridges 210a to 210d. Accordingly, this ink jet printer has cartridge holders 220a to 220d are different in shape from the cartridge holders 20a to 20d. Otherwise the two ink jet printers are similar, and no detailed description is given of the ink jet printer according to this embodiment.

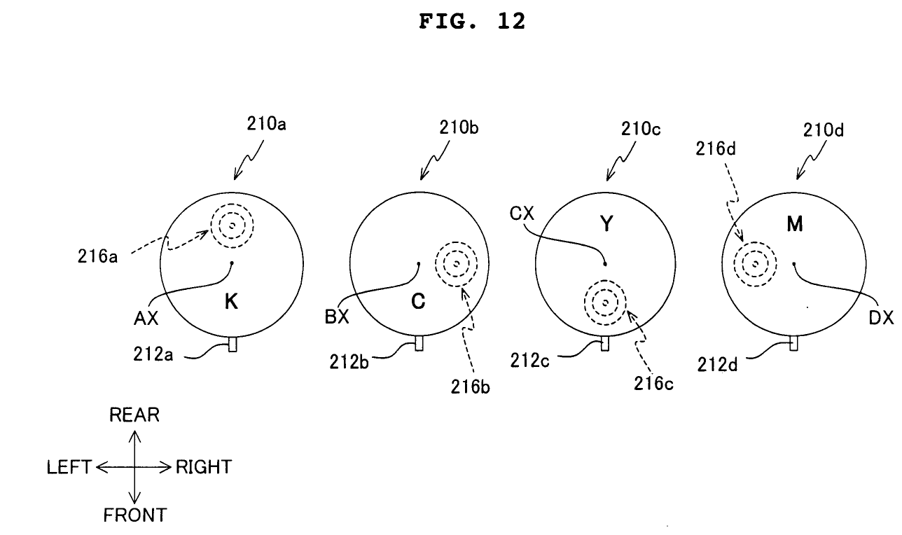

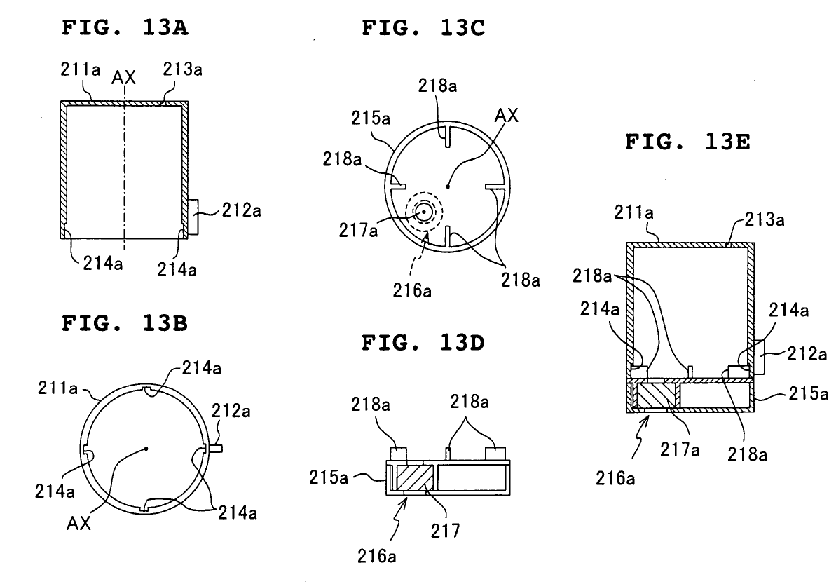

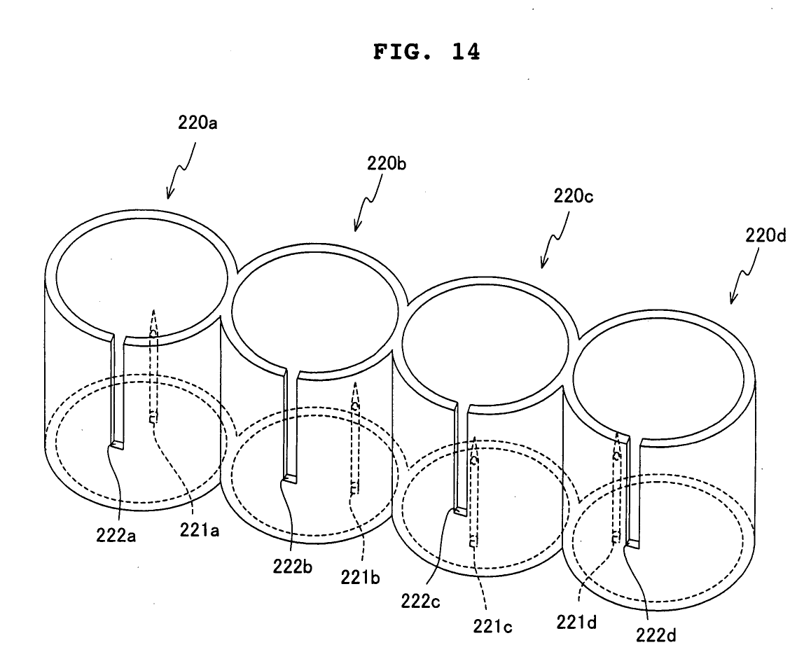

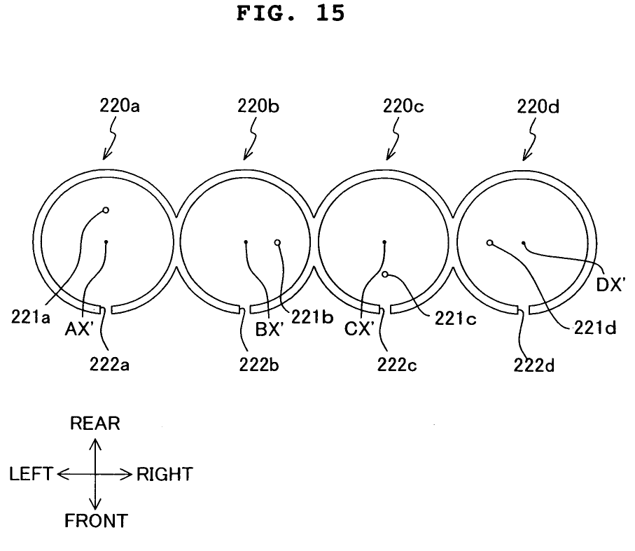

With reference to FIGS. 11, 12 and 13A-13E, the structure of the ink cartridges 210a to 210d is described below in detail. FIGS. 11 and 12 are a perspective view and a top view respectively of ink cartridges 210a to 210d. FIGS. 13A to 13D schematically show the structure of the ink containers 211a and lid 215a of the black ink cartridge 210a. FIGS. 13A and 13B are a vertical cross section and a bottom view respectively of the ink container 211a. FIGS. 13C and 13D are a top view and a vertical cross section respectively of the lid 215a. FIG. 13E is a vertical cross section of the ink cartridge 210a in which the ink containers 211a and lid 215a are joined together.

The ink cartridge 210a consists of an ink container 211a and a lid 215a which are joined together. As shown in FIGS. 11, 13A, 13B and 13E, the ink container 211a is substantially cylindrical. One end of the ink container 211a is closed except for an air hole 213a, and the other end is open.

As shown in FIGS. 13A and 13B, the ink container 211a has four grooves (recesses) 214a cut inside its bottom (open end). The grooves 214a are positioned on two lines crossing at right angles at the axis of the ink container 211a. Accordingly, the bottom of the ink container 211a is thin at the grooves 214a.

The lid 215a closes an opening of the bottom of the ink container 211a and the projected configuration of the lid 215a is approximately same as that of the container 211a. As shown in FIGS. 13C and 13D, the lid 215a has four ribs 218a protruding upward from the top thereof (the surface joined to the container 211a) in the vicinity of the outer periphery of the lid 215a. The ribs 218a are positioned on two lines crossing at right angles at the axis of the lid 215a. The outer end of each rib 218a is spaced inward from the outer edge of the lid 215a by a predetermined distance, which is nearly equal to the distance between the outer cylindrical surface of the ink container 211a and the bottom of each container groove 214a.

The four grooves 214a of the ink container 211a are substantially same in width and height to the outer ends of the ribs 218a of the lid 215a. Accordingly, when the lid 215a is joined to the ink container 211a, the outer ends of the ribs 218a can engage with the grooves 214a. The four grooves 214a and the outer ends of the four ribs 218a are same in shape and positioned at angularly regular intervals in rotation symmetry with the axis AX. Accordingly, when the lid 215a is joined to the ink container 211a, the lid 215a can be in any one of four joining postures by being turned by 90 degrees about the axis AX at a time.

FIG. 13E shows the black ink cartridge 210a formed by joining the lid 215a in one of the four postures relative to the ink container 211a.

The ink containers 211a-211d of the black, cyanic, yellow and magenta ink cartridges 210a-210d are same in structure. The lids 215a-215d of the ink cartridges 210a-210d are same in structure. Each of the lids 215a-215d of the ink cartridges 210a-210d is joined in a different posture to the associated ink container 211a, 211b, 211c or 211d.

FIG. 12 is a top view of the ink cartridges 210a to 210d produced by joining the lids 215a to 215d in the four postures to the ink containers 211a-211d respectively. In FIG. 12, front/near and left/right directions are indicated by arrows for explanation of configuration of the cartridges 120a to 120d.

As shown in FIG. 12, the projection 212a of the black ink cartridge 210a is arranged at the front side, and the insertion part 216a is arranged off the axis AX of the ink cartridge 210a toward the rear side opposite to the front side where the projection 212a is arranged. Likewise, the projection 212b of the cyan ink cartridge 210b is arranged at the front side, and the insertion part 216b is arranged off the axis BX of the ink cartridge 210b toward the right side.

Likewise, the projection 212c of the yellow ink cartridge 210c is arranged at the front side, and the insertion part 216c is arranged off the axis CX of the ink cartridge 210c toward the front side where the projection 212c is positioned. Likewise, the projection 212d of the magenta ink cartridge 210d is arranged at the front end, and the insertion part 216d is arranged off the axis DX of the ink cartridge 210d toward the left side.

As shown in FIG. 12, each of the insertion parts 216a to 216d is positioned eccentric from (positioned off) the axes AX, BX, CX or DX of the ink cartridge 210a, 210b, 210c or 210d.

FIG. 12 shows the black, cyan, yellow and magenta ink cartridges 210a to 210d in that order from the left side to the right side. Each of the projections 212a to 212d is arranged differently relative to the associated insertion part 216a, 216b, 216c or 216d. In other words, the projections 212a, 212b, 212c or 212d and insertion parts 216a, 216b, 216c or 216d of each of the ink cartridges 210a to 210d have a different pattern of the positional relationship therebetween as seen in the direction in which the cartridge is mounted.

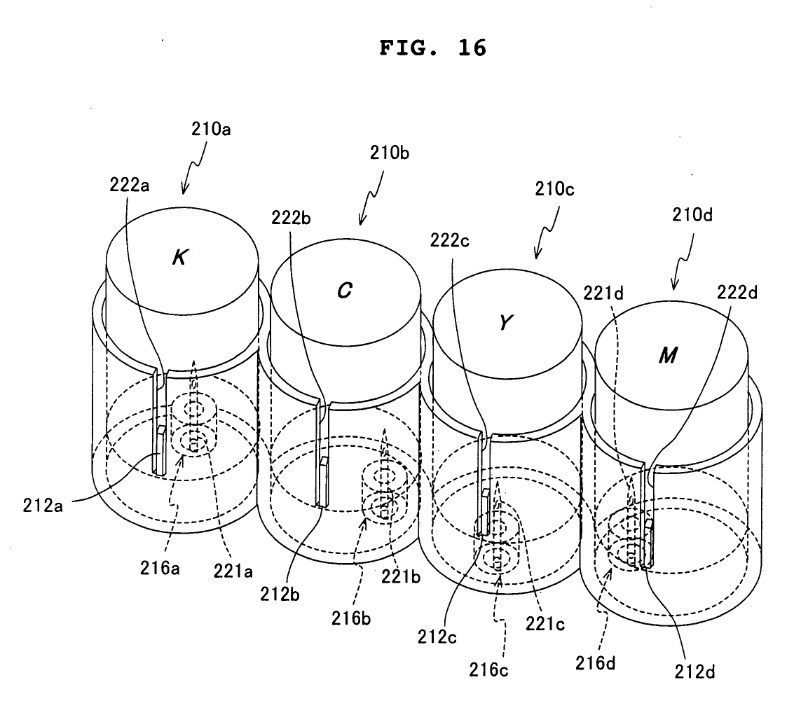

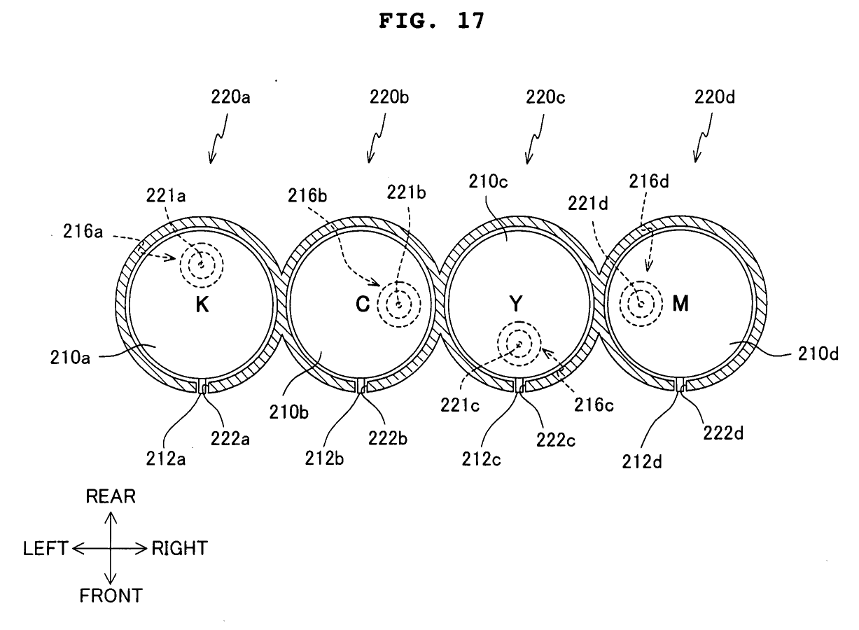

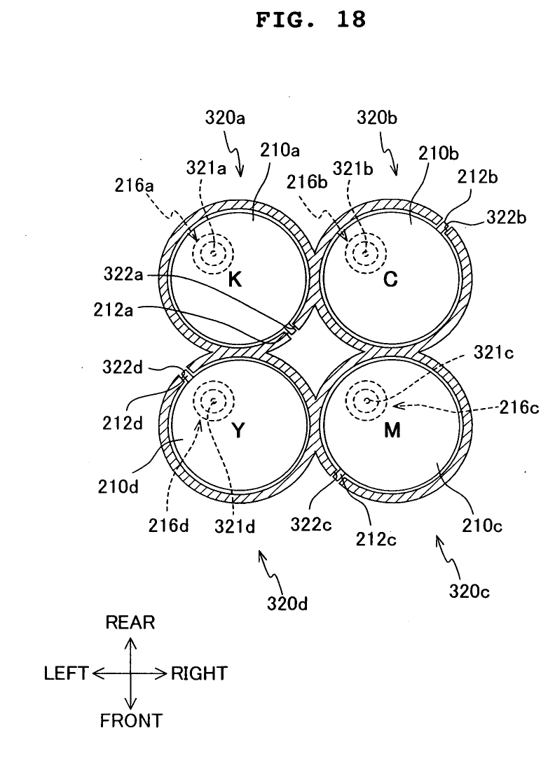

With reference to FIGS. 14 and 15, the structure of the cartridge holders 220a-220d is described below in detail. FIGS. 14 and 15 are a perspective view and a top view respectively of the cartridge holders 220a to 220d. FIGS. 16 and 17 are a perspective view and a top view respectively of the cartridge holders 220a to 220d with the ink cartridges 210a to 210d mounted thereon. In FIG. 15, front/near and left/right directions are indicated by arrows for explanation of configuration of the cartridge holders 220a to 220d. In FIG. 17, the upper/lower and left/right directions corresponding to the view of FIG. 15 are shown by arrows for explanation of the configuration of the cartridge holders 220a to 220d.

As shown in FIG. 14, the cartridge holders 220a to 220d have a substantially cylindrical shaped member on which the ink cartridges 210a to 210d are mounted respectively. The cartridge holders 220a to 220d are arranged in a line. The internal spaces of the cartridge holders 220a to 220d are approximately equal to the horizontally sectional area of the ink cartridges 210a to 210d. The cartridge holders 220a to 220d are an integrally formed as like a molded member.

Ink introducing tubes 221a to 221d are provided on the bottom surface of the cartridge holders 220a to 220d respectively to protrude upwardly therefrom. Each of the ink introducing tubes 221a to 221d is eccentric from (positioned off) each of the axes AX′, BX′, CX′or DX′ of the cartridge holder 220a, 220b, 220c or 220d. The tip of each of the introducing tubes 221a-221d is positioned at nearly equal distances from the top and the bottom of the cartridge holder 220a, 220b, 220c or 220d.

The cartridge holders 220a to 220d have slits 222a to 222d cut in their respective cylindrical side walls with which the projections 212a to 212d of the ink containers 211a to 211d are engaged. Each of the slits 222a to 222d extends downwardly from the top of the cartridge holder 220a, 220b, 220c or 220d toward the middle of the holder in the height thereof. The slits 222a to 222d are formed in the same position (at the front side in FIG. 15) in the cartridge holders 220a to 220d respectively.

As shown in FIG. 15, the slit 222a of the cartridge holder 220a for the black ink cartridge is arranged at the front side, and the ink introducing tube 221a is arranged eccentric from the axis AX′ toward the rear side. Likewise, the slit 222b of the cartridge holder 220b for the cyan ink cartridge is arranged at the front side, and the ink introducing tube 221b is arranged eccentric from the axis BX′ toward the right side.

Likewise, the slit 222c of the cartridge holder 220c for the yellow ink cartridge is arranged at the front side, and the ink introducing tube 221c is arranged eccentric from the axis CX′ toward the front side. Likewise, the slit 222d of the cartridge holder 220d for the magenta ink cartridge is arranged at the front side, and the ink introducing tube 221d is arranged eccentric from the axis DX′ toward the left side.

FIG. 15 shows the cartridge holders 220a to 220d for the black, cyan, yellow and magenta ink cartridges 210a to 210d respectively in this order from the left side from the right side. Each of the slits 222a to 222d is arranged differently relative to the associated introducing tube 221a, 221b, 221c or 221d. In other words, the slit 222a, 222b, 222c or 222d of each of the cartridge holders 220a to 220d and introducing tube 221a, 221b, 221c or 221d have a different pattern of positional relationship therebetween as seen in the direction in which the associated ink cartridge 210a, 210b, 210c or 210d is mounted.

As understood from the foregoing description, the pattern of positional relationship between the projection 212a, 212b, 212c or 212d and insertion part 216a, 216b, 216c or 216d of each of the black, cyan, yellow and magenta ink cartridges 210a to 210d is same as that of the slit 222a, 222b, 222c or 222d of the associated cartridge holder 220a, 220b, 220c or 220d and ink introducing tube 221a, 221b, 221c or 221d. Accordingly, as shown in FIGS. 16 and 17, the ink cartridges 210a to 210d can be appropriately mounted in the proper cartridge holders 220a to 220d respectively without misfit by the user.

Thus, as is the case with the first embodiment, it is possible to prevent any one of the ink cartridges 210a to 210d from being mounted by mistake in any one of the cartridge holders 220a to 220d to which the ink cartridge does not correspond. Because the identical ink containers 211a to 211d and identical lids 215a to 215d can be used in common for all ink cartridges 210a to 210d, the cartridges can be produced at low cost.

Because the cartridge holders 220a to 220d are arranged in a line, it is possible to reduce the width of a section in the printer in which the cartridge holders 220a to 220d are provided.

Because the ink containers 211a to 211d and lids 215a to 215d are circular in cross section, it is possible to determine any number of postures in which the lids can be joined to the containers. In other words, by setting any turning angle of each of the lids 215a to 215d relative to one of the ink containers 211a to 211d when joining the lid to the container, it is possible to determine a number of joining postures without using special structure or member. Accordingly, it is possible to assemble even more than four ink cartridges for different colors from one type of ink container and one type of lid.

Because the slits 222a to 222d are arranged in the same position relative to the cartridge holders 220a to 220d respectively, it is possible to mount the ink cartridges in the cartridge holders, with the projections 212a to 212d oriented in the same direction.

In this embodiment, the lid 215a is joined to the ink container 211a, with the four ribs 218a engaging with the four grooves 214a. Thus, the grooves 214a and ribs 218a determine four postures in any one of which the lid 215a can be joined to the ink container 211a. However, any arbitrary joining structure may be adopted in which the lid 215a can be joined to the ink container 211a by any joints other than grooves and ribs. For example, the cylindrical circumference of the top of the lid 215a may be extended upwardly to have a ring-shaped form for engaging with the bottom of the ink container 211a. In this case, the top of the lid 215a and the bottom of the ink container 211a would be joining parts, and the rotational angles (90 degrees each) about the axis AX at which the lid 215a can be joined in four postures to the ink container 211a make it possible to assemble four different ink cartridges. It is preferable that marks be put on the ink container 211a and lid 215a to easily distinguish their joining orientations.

### Forth Embodiment

With reference to FIGS. 18, an ink jet printer according to a fourth embodiment of the present invention is described below. FIG. 18 is a top view of the cartridge holders 320a to 320d of the printer according to this embodiment with the ink cartridges 210a to 210d mounted thereon. In FIG. 18, front/near and left/right directions are indicated by arrows for explanation of configuration of the cartridges 320a to 320d.

As described above, the cartridge holders 220a to 220d of the printer according to the third embodiment are arranged in a line. The ink jet printer according to the fourth embodiment differs from that according to the third embodiment mainly in that the cartridge holders 320a to 320d are arranged in the form of a lattice. Otherwise the two ink jet printers are similar, and no detailed description is given of the ink jet printer according to this embodiment.

The cartridge holders 320a to 320d have a substantially cylindrical-shaped member on which black, cyan, yellow and magenta ink cartridges 210a to 210d are mounted respectively. As shown in FIG. 18, the cartridge holders 320a to 320d are arranged in the form of a lattice. The structure of the ink cartridges 210a to 210d is as described for the third embodiment.

Ink introducing tubes 321a to 321d are provided in the bottoms of the cartridge holders 320a to 320d respectively to protrude upwardly therefrom. The cartridge holders 320a to 320d have slits 322a to 322d cut in their respective cylindrical walls with which the projections 212a to 212d of the ink containers 211a to 211d are engaged.

The slit 322a, 322b, 322c or 322d of each of the cartridge holders 320a to 320d and the introducing tube 321a, 321b, 321c or 321d have a different pattern of the positional relationship therebetween as seen in the direction in which the associated ink cartridge 210a, 210b, 210c or 210d is mounted. The introducing tubes 321a to 321d are arranged in the same position relative to the cartridge holders 320a to 320d respectively. Specifically, each of the introducing tubes 321a to 321d is arranged off the center toward the rear-left side of the associated cartridge holder 320a, 320b, 320c or 320d in FIG. 18.

Thus, as is the case with the third embodiment, it is possible to prevent any one of the ink cartridges 210a to 210d from being mounted by mistake in any one of cartridge holders 320a to 320d to which the ink cartridge does not correspond.

Because the cartridge holders 320a to 320d are arranged in the form of a lattice, it is possible to arrange the holders in a compact manner.

Because the ink introducing tubes 321a to 321d are arranged in the same position relative to the cartridge holders 320a to 320d respectively, it is possible to mount the ink cartridges 210a to 210d on the cartridge holders 320a-320d respectively, with the ink insertion parts 216a to 216d oriented in the same direction.

### Fifth Embodiment

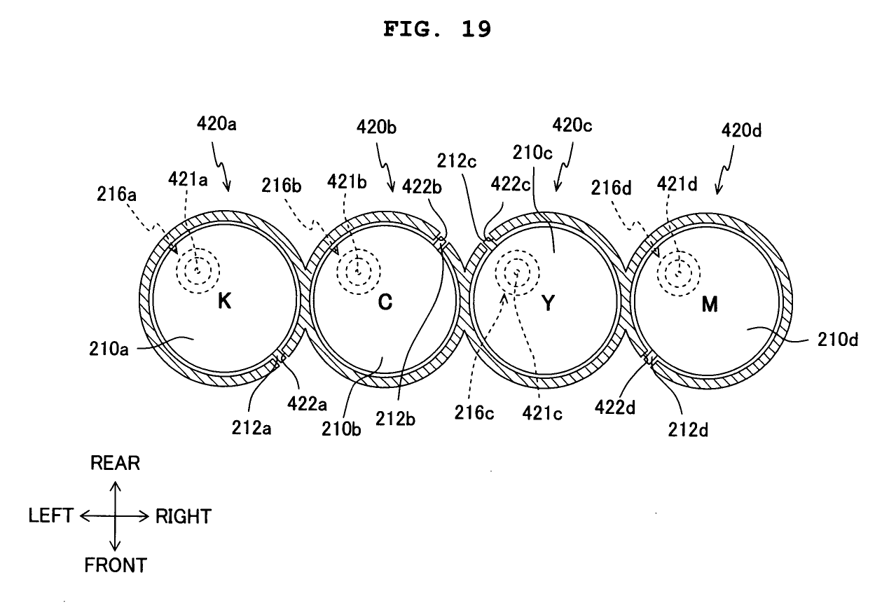

With reference to FIG. 19, an ink jet printer according to a fifth embodiment of the present invention is described below. FIG. 19 shows the cartridge holders 420a to 420d of the printer with the ink cartridges 210a to 210d mounted thereon. In FIG. 19, front/near and left/right directions are indicated by arrows for explanation of configuration of the cartridges 420a to 420d.

As described above, the ink introducing tubes 221a to 221d of the ink jet printer according to the third embodiment are arranged differently relative to the cartridge holders 220a to 220d respectively. The ink jet printer according to the fifth embodiment differs from that according to the third embodiment mainly in that the cartridge holders 420a to 420d have ink introducing tubes 421a to 421d each of which is arranged in the same position relative to the associated holder. Otherwise the two ink jet printers are similar, and no detailed description is given of the ink jet printer according to the fifth embodiment.

The cartridge holders 420a to,420d have a substantially cylindrical-shaped member on which black, cyan, yellow and magenta ink cartridges 210a to 210d are mounted respectively. As shown in FIG. 19, the cartridge holders 420a to 420d are arranged in a line. The structure of the ink cartridges 210a to 210d is as described for the third embodiment.

Ink introducing tubes 421a to 421d are provided in the bottoms of the cartridge holders 420a to 420d respectively to protrude upwardly therefrom. The cartridge holders 420a to 420d have slits 422a to 422d cut in their respective side cylindrical walls with which the projections 212a to 212d of the ink containers 211a to 211d are engaged.

The slit 422a, 422b, 422c or 422d of each of the cartridge holders 420a to 420d and the introducing tube 421a, 421b, 421c or 421d have a different pattern of the positional relationship therebetween as seen in the direction in which the associated ink cartridge 210a, 210b, 210c or 210d is mounted. The ink introducing tubes 421a to 421d are arranged in the same position relative to the cartridge holders 420a to 420d respectively. Specifically, each of the ink introducing tubes 421a to 421d is arranged off the center toward the rear-left side of the associated cartridge holder 420a, 420b, 420c or 420d in FIG. 19.

Thus, as is the case with the third embodiment, it is possible to prevent any one of the ink cartridges 210a to 210d from being mounted by mistake in any one of cartridge holders 420a to 420d to which the ink cartridge does not correspond.

Because the cartridge holders 420a to 420d are arranged in a line, it is possible to reduce the width of a section in the printer where the holders are provided.

Because the ink introducing tubes 421a to 421d are arranged in the same position relative to the cartridge holders 420a to 420d respectively, it is possible to mount the ink cartridges 210a to 210d in the cartridge holders 420a to 420d respectively, with the ink insertion parts 216a to 216d oriented in the same direction.

### Sixth Embodiment

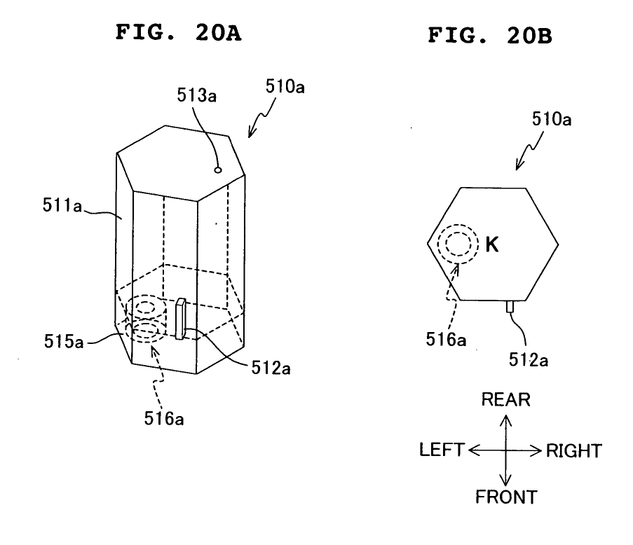

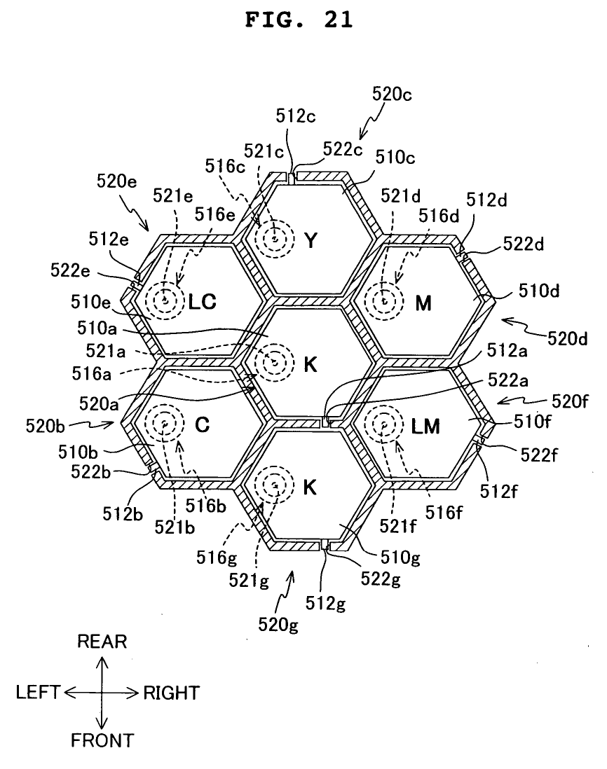

With reference to FIGS. 20A, 20B and 21, an ink jet printer according to a sixth embodiment of the present invention is described below. In FIG. 20B, front/near and left/right directions are indicated by arrows for explanation of configuration of the cartridge 510a.

As described above, the ink jet printer 1 according to the first embodiment is for use with four ink cartridges 10a to 10d square in horizontal cross section. The ink jet printer according to the sixth embodiment differs from the ink jet printer 1 mainly in being for use with seven ink cartridges 510a to 510g hexagonal in horizontal cross section. The two ink cartridges 510a and 210g are black ink cartridges, which are ink cartridges of high consumption. This ink jet printer has cartridge holders 520a to 520g different in shape from the cartridge holders 20a to 20d. Otherwise the two ink jet printers are similar, and no detailed description is given of the ink jet printer according to the sixth embodiment.

With reference to FIGS. 20A and 20B, the structure of the ink cartridges 510a to 510g is described below in detail. FIGS. 20A and 20B are a perspective view and a top view respectively of the ink cartridge 510a. The ink cartridges 510a to 510g are filled with black, cyan, yellow, magenta, light cyan, light magenta and black inks respectively. Only the black ink cartridge 510a is described below in detail.

The ink cartridge 510a consists of an ink container 511a and a lid 515a which are joined together. The ink container 511a is a tubular member which is hexagonal in horizontal cross section. The ink container 511a is closed at one end thereof except for an air hole 513a, and is open at the other end.

The ink container 511a has six grooves (not shown) cut inside bottom thereof (open end) each of the six grooves is arranged in the middle of one of the six sides of the bottom. The lid 515a closes an opening of the bottom of the ink container 511a. The top (surface joined to the container 511a) of the lid 515a has six ribs (not shown) formed near the outer periphery thereof, each of which is provided in the middle of one of the six sides of the top to protrude upwardly therefrom. The six grooves of the ink container 511a and the six ribs of the lid 515a are similar in structure to the four recesses 14a of the ink container 11a and the ribs 18a of the lid 15a respectively of the first embodiment. Accordingly, it is possible to join the lid 515a in any one of six joining postures to the ink container 511a by turning the lid 515a by 60 degrees at a time.

The ink containers of the black, cyan, yellow, magenta, light cyan, light magenta and black ink cartridges 510a to 510g are same in structure. The lids of the ink cartridges 510a to 510g are same in structure. Each of the ink containers of the ink cartridges 510a to 510f is joined in a different posture to the associated ink container. Each of the ink containers of the same type ink cartridges 510a and 510g is joined in the same posture to the associated ink container.

FIG. 21 is a top view of the cartridge holders 520a to 520g of the ink jet printer according to this embodiment with the ink cartridges 510a and 510g mounted thereon. In FIG. 21, front/near and left/right directions are indicated by arrows for explanation of configuration of the cartridges 520a to 520g. As seen from FIG. 21, the ink cartridges 510a and 510g have insertion parts 516 to 516g respectively each of which is arranged off the center of the associated cartridge.

The cartridge holders 520a to 520g have a member which is substantially hexagonal in horizontal cross section and on which the ink cartridges 510a and 510g can be mounted respectively. The internal spaces of the cartridge holders 520a to 520g are nearly equal in horizontally sectional area to the ink cartridges 510a to 510g.

Ink introducing tubes 521a to 521g are provided in the bottoms of the cartridge holders 520a to 520g respectively to protrude upwardly therefrom. Each of the introducing tubes 521a to 521g is eccentric from (positioned off) the center of the associated cartridge holder 520a, 520b, 520c, 520d, 520e, 520f or 520g. The ink introducing tubes 521a to 521g are arranged in the same position near the left side (corner) of the cartridge holders 520a to 520g respectively. The cartridge holders 520a to 520g have slits 522a to 522g respectively cut in peripheral walls thereof with which the projections 512a to 512g of the ink containers 511a to 511g are respectively engaged.

As shown in FIG. 21, the projection 512a, 512b, 512c, 512d, 512e or 512f and insertion part 516a, 516b, 516c, 516d, 516e or 516f of each of the black, cyan, yellow, magenta, light cyan and light magenta ink cartridges 510a to 510f have a different pattern of the positional relationship therebetween as seen in the direction on which the cartridge is mounted. The slit 522a, 522b, 522c, 522d, 522e or 522f of each of the cartridge holders 520a to 520f and the introducing tube 521a, 521b, 521c, 521d, 521e or 521f of have a different pattern of the positional relationship therebetween as seen in the direction on which the associated ink cartridge 510a, 510b, 510c, 510d, 510e or 510f is mounted.

As understood from the foregoing description, the pattern of the positional relationship between the projection 512a, 512b, 512c, 512d, 512e or 512f and the insertion part 516a, 516b, 516c, 516d, 516e or 516f of each of the black, cyan, yellow, magenta, light cyan and light magenta ink cartridges 510a to 510f is same as that of the slit 522a, 522b, 522c, 522d, 522e or 522f and the ink introducing tube 521a, 521b, 521c, 521d, 521e or 521f of the associated cartridge holder 520a, 520b, 520c, 520d, 520e or 520f. Accordingly, the ink cartridges 510a to 510f can be appropriately mounted in the proper cartridge holders 520a to 520f respectively without any misfit by the user.

The pattern of the positional relationship between the projection 512a and insertion part 516a of the ink cartridge 510a is same as that of the projection 512g and insertion part 516g of the ink cartridge 510g. The pattern of the positional relationship between the slit 522a and ink introducing tube 521a of the cartridge holder 520a is same as that of the slit 522g and ink introducing tube 521g of the cartridge holder 520g. Accordingly, each of the ink cartridges 510a and 510g can be mounted in either of the cartridge holders 520a and 520g.

Thus, as is the case with the first embodiment, it is possible to prevent any one of the ink cartridges 510a to 510g from being mounted by mistake in any one of the cartridge holders 520a to 520g to which the ink cartridge does not correspond. Because the identical ink containers 511a to 511g and identical lids 215a to 215g can be used in common for all ink cartridges 510a to 510g, six types of ink cartridges 510a to 510f can be produced from one type of ink container and one type of lid, so that the cartridges can be produced at low cost.

Because the ink introducing tubes 521a to 521g are arranged in the same position relative to the cartridge holders 520a to 520g respectively, it is possible to mount the ink cartridges 510a to 510g in the cartridge holders 520a to 520g respectively, with the insertion parts 516a to 516g oriented in the same direction.

Because the ink containers 511a to 511g and lids 515a to 515g are hexagonal in horizontal cross section, it is easy to determine different joining postures in which they can be joined together. The number of postures in which the lids 515a to 515g can be joined to the ink containers 511a to 511g equals the number of sides of a hexagon. Accordingly, it is possible to determine different joining postures without using special structure or member. In this embodiment, the six grooves and the six ribs determine six postures in which the lids 515a to 515g can be joined to the ink containers 511a to 511g. However, any arbitrary joining construction may be adopted in which the lids 515a to 515g can be joined to the ink containers 511a to 511g by any means other than grooves and ribs.

The preferred embodiments of the present invention have been described hereinbefore, but the present invention is not limited thereto. The invention may be modified into various forms within the scope of the appended claims. For example, in each of the embodiments, the cartridge holders are arranged in a line or in the form of a lattice. The cartridge holders might be arranged otherwise. The cartridge holders need not to be formed of a single member, but may be formed of separate members.

In each of the embodiments, the ink cartridges are square or hexagonal in horizontal cross section, or cylindrical. However, the ink cartridges might be formed otherwise and take the form of polygons other than a square and a hexagon in horizontal section. Should the ink cartridges be neither polygonal in horizontal cross section nor cylindrical, they may be joined together by joints which are in rotation symmetry for engagement in different orientations.

In the embodiments, each of the ink containers has a projection, and each of the lids has an insertion part as an ink supply port. Alternatively, each of the ink containers may have an insertion part formed at bottom thereof, and each of the lids may have a projection.

In each of the embodiments, each of the ink cartridges has a projection, and each of the cartridge holders has a slit for engagement with one of the projections of the cartridges. Alternatively, each of the cartridge holders may have a projection, and each of the ink cartridges may have a slit (a groove) for engagement with one of the projections of the cartridges.

In each of the embodiments, the ink cartridges are prevented from being mounted in wrong cartridge holders of the ink jet printer. An apparatus other than ink jet printers may have cartridge holders each of which has a positioning part. The positioning part can engage with the engaging part of one of the ink cartridges according to the present invention. The positioning parts of the cartridge holders prevent the ink cartridges from being mounted in wrong cartridge holders. For example, an apparatus for filling empty ink cartridges with different inks has cartridge holders each of which has a positioning part. The positioning part can engage with the engaging part of one of the ink cartridges. The positioning parts of the cartridge holders prevent the ink cartridges from being mounted in wrong cartridge holders and filled with wrong inks.

In the embodiments, each of the ink cartridges includes an insertion part as an ink supply port formed at one end thereof (the lid) and has an air hole cut through the other end (the closed end of the ink container). The present invention may be applied to ink cartridges each of which has both an ink supply port and an air intake port formed at one end thereof (for example, ink cartridges from which ink is supplied through buffer tanks to an ink jet head). In this case, as is the case with the embodiments, the ink supply port is positioned off the center of the lid of the ink cartridge. The air intake port is arranged at the center of the lid. This enables the positions of the air intake ports to be common in ink cartridges where the lids are joined in different postures to the ink containers.

What is claimed is:

1. A set of plurality of ink cartridges, wherein:
each of the ink cartridges comprises:
a wall;
an ink supplying part positioned at the wall: and
a projection; and
the cartridge having different patterns from each other in a positional relationship among the ink supplying part, the projection and a center of the wall, as seen from a direction perpendicular to the wall.
